(19) United States
(12) Patent Application Publication
(10) Pub. No.: US 2019/0037291 A1
(43) Pub. Date: Jan. 31, 2019

(54) Front Cover for Earpiece

(71) Applicant: Innovation Sound Technology Co., Ltd., Shenzhen, Guangdong (CN)

(72) Inventors: Shun Ming YUEN, Shenzhen, Guangdong (CN); Lei ZHENG, Shenzhen, Guangdong (CN); Chunyan MO, Shenzhen, Guangdong (CN)

(21) Appl. No.: 16/073,772

(22) PCT Filed: Jan. 27, 2016
(86) PCT No.: PCT/CN2016/072267

§ 371 Date: Jul. 27, 2018

(51) Int. Cl. H04R 1/02; H04R 1/10; H04R 5/033

(52) U.S. Cl. CPC H04R 1/02; H04R 5/033; H04R 1/1058

(57) ABSTRACT

A front cover for protecting a diaphragm of an earpiece is disclosed. A circular through hole is provided at the center of the front cover. A series of trapezoidal through holes surrounding the circular through hole are provided at fixed intervals encircling the circular through hole. The total area of the circular through hole and the trapezoidal through holes accounts for 40% to 55% of the area of the front cover. By verifying the effect of different shapes and different hole areas on a frequency response curve, and by designing a front cover according to the curvature and shape of a diaphragm and adjusting the hole areas to optimize the frequency response curve of an earpiece, the earpiece front cover enables expansion of the effective frequency bandwidth of an earpiece, smoothing out of the high frequency curve, and reducing acoustic peaks and valleys.

### TECHNICAL FIELD

The disclosure relates to a protective front cover for an earphone diaphragm, and particularly to a design that holes are provided on the protective front cover for an earphone diaphragm.

### BACKGROUND

A moving-coil earphone is a most ordinary and common earphone. A driving unit of the moving-coil earphone is substantially a small size moving-coil speaker in which a voice coil in a permanent magnetic field drives a vibration membrane (or diaphragm) connected to the voice coil to vibrate. The moving-coil earphone has a high efficiency, can output driving power to an earphone of audio equipment, and is reliable and durable.

To effectively protect a diaphragm of an earphone, a covering plate (or front cover) is usually added in front of the diaphragm of the earphone. At present, there is no general conclusion regarding influence, of design of a protective front cover for an earphone (particularly, the shape, position and size of opening holes), on a frequency-response curve. In most cases, design is made according to requirements on structure and appearance. And it results in a fact that a high-frequency portion of the curve cannot meet sound quality requirement of the earphone.

### SUMMARY

The disclosure is intended to provide a protective front cover for an earphone diaphragm, which has holes with optimized structure and area.

To this end, there is provided a protective front cover for an earphone diaphragm, wherein a circular through hole is provided at a center of the front cover, a periphery of the circular through hole is provided with an array of trapezoidal through holes that are spaced apart from each other and enclose the circular through hole, and a total area of the circular through hole and the trapezoidal through holes is 40% to 55% of an area of the front cover.

In an embodiment, the front cover comprises a dome portion, an outer arc portion connected with an outer edge of the dome portion and a support connecting portion connected with an outer edge of the outer arc portion, the circular through hole is provided at a center of the dome portion, and the array of trapezoidal through holes are provided on the outer arc portion.

In an embodiment, the front cover is in the shape of a dome, and the circular through hole is provided at a center of the dome.

In an embodiment, a top surface of the front cover is a plane, and the circular through hole is provided at a center of the top surface.

There is further provided a protective front cover for an earphone diaphragm, wherein at least four arc through holes that form an annulus are provided at a center of the front cover, a periphery of the arc through holes is provided with an array of trapezoidal through holes that are spaced apart from each other and enclose the arc through holes, and a total area of the arc through holes and the trapezoidal through holes is 40% to 55% of an area of the front cover.

In an embodiment, the front cover comprises a dome portion, an outer arc portion connected with an outer edge of the dome portion and a support connecting portion connected with an outer edge of the outer arc portion, the at least four arc through holes that form an annulus are provided at a center of the dome portion, and the array of trapezoidal through holes are provided on the outer arc portion.

In an embodiment, the front cover is in the shape of a dome, and the at least four arc through holes that form an annulus are provided at a center of the dome.

In an embodiment, a top surface of the front cover is a plane, and the at least four arc through holes that form an annulus are provided at a center of the top surface.

Embodiments of the disclosure have the following beneficial effects.

By experiments made to determine influences on the frequency-response curve using protective front cover having different shape and hole areas, the front cover according to embodiments of the disclosure is designed according to the arc shape of the diaphragm and has an appropriately adjusted hole area. Thus, the frequency-response curve of the earphone is optimized, and the earphone is enabled to have an extended effective frequency width, a smooth high-frequency portion and a reduced number of peaks and valleys.

### BRIEF DESCRIPTION OF THE DRAWINGS

The protective front cover of an earphone diaphragm according to embodiments of the disclosure is elaborated below with reference to drawings.

FIG. 1 is a schematic structure diagram of a first front cover according to a first embodiment;

FIG. 2 is a schematic structure diagram of a first front cover, which shows holes, according to a first embodiment;

FIG. 3 is a schematic structure diagram of a second front cover according to a second embodiment;

FIG. 4 is a schematic structure diagram of a third front cover according to a first embodiment; and

FIG. 5 is a schematic structure diagram of a first front cover, which shows holes, according to a second embodiment.

### DETAILED DESCRIPTION OF THE INVENTION

### First Embodiment

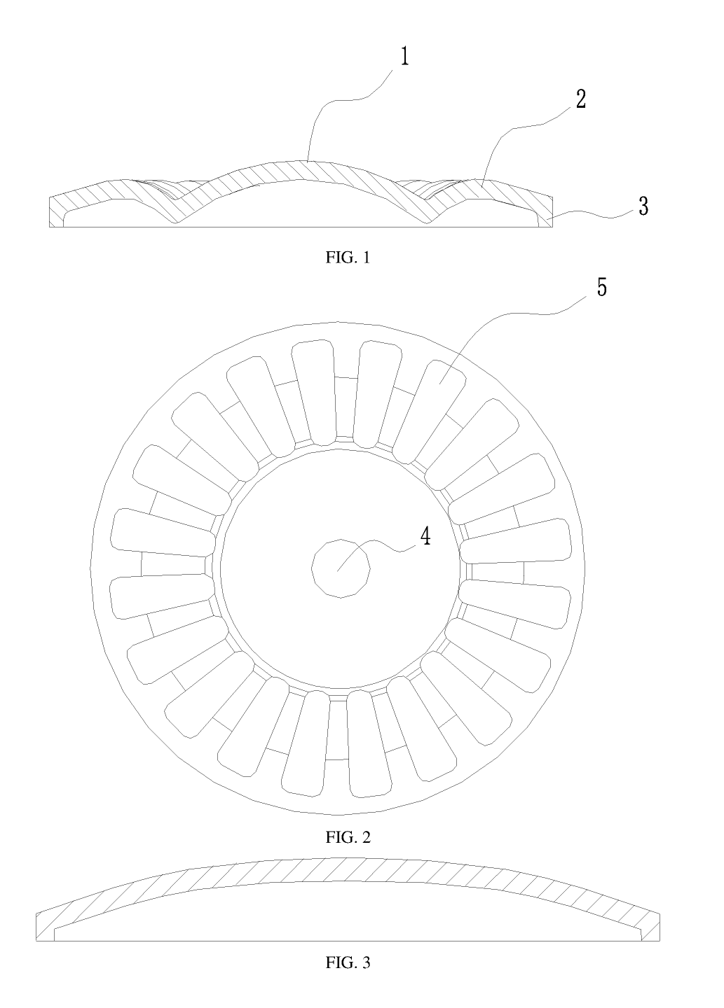

As shown in FIG. 1, a first protective front cover for an earphone diaphragm in the embodiment includes a dome portion 1, an outer arc portion 2 connected with an outer edge of the dome portion 1 and a support connecting portion 3 connected with an outer edge of the outer arc portion 2.

A circular through hole 4 is provided at a center of the dome portion 1.

A periphery of the circular through hole 4 is provided with an array of trapezoidal through holes that are spaced apart from each other and enclose the circular through hole, and the array of trapezoidal through holes are provided on the outer arc portion 2.

As shown in FIG. 2, a total area of the circular through hole 4 and the trapezoidal through holes 5 is 40% of an area of the front cover. Certainly, the total area of the circular through hole 4 and the trapezoidal through holes 5 may also be 55% of the area of the front cover.

Another kind of front cover, referred to as a second front cover, may also be conceived. As shown in FIG. 3, the second front cover is in the shape of a dome, and the circular through hole 4 is provided at a center of the dome.

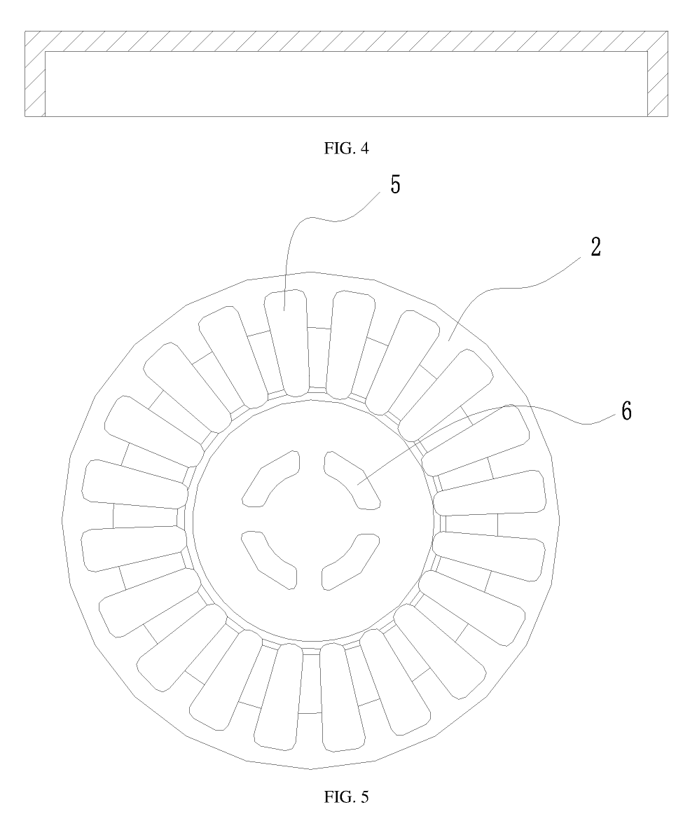

Another kind of front cover, referred to as a third front cover, may also be conceived. As shown in FIG. 4, a top surface of the third front cover is a plane, and the circular through hole 4 is provided at a center of the top surface.

### Second Embodiment

As shown in FIG. 5, a first protective front cover for an earphone diaphragm in the embodiment includes a dome portion 1, an outer arc portion 2 connected with an outer edge of the dome portion 1 and a support connecting portion 3 connected with an outer edge of the outer arc portion 2.

At least four arc through holes 6 that form an annulus are provided at a center of the dome portion 1. Certainly, there may be five, six or more arc through holes.

A periphery of the four arc through holes 6 that form an annulus is provided with an array of trapezoidal through holes 5 that are spaced apart from each other and enclose the arc through holes 6, and the array of trapezoidal through holes 5 are provided on the outer arc portion 2.

A total area of the four arc through holes 6 that form an annulus and the trapezoidal through holes 5 is 40% of an area of the front cover.

Certainly, the total area of the four arc through holes 6 that form an annulus and the trapezoidal through holes 5 may also be 55% of the area of the front cover.

Another kind of front cover, referred to as a second front cover, may also be conceived. The second front cover is in the shape of a dome, and the four arc through holes 6 that form an annulus is provided at a center of the dome.

Another kind of front cover, referred to as a third front cover, may also be conceived. A top surface of the third front cover is a plane, and the four arc through holes 6 that form an annulus is provided at a center of the top surface.

The disclosure is not limited to the above embodiments. Technical solutions according to above embodiments can be combined to obtain new technical solutions. In addition, all equivalents of the technical solutions of the disclosure fall within the scope of the claims.

1. A protective front cover for an earphone diaphragm, wherein a circular through hole is provided at a center of the front cover, a periphery of the circular through hole is provided with an array of trapezoidal through holes that are spaced apart from each other and enclose the circular through hole, and a total area of the circular through hole and the trapezoidal through holes is 40% to 55% of an area of the front cover.

2. The protective front cover for an earphone diaphragm according to claim 1, wherein the front cover comprises a dome portion, an outer arc portion connected with an outer edge of the dome portion and a support connecting portion connected with an outer edge of the outer arc portion, the circular through hole is provided at a center of the dome portion, and the array of trapezoidal through holes are provided on the outer arc portion.

3. The protective front cover for an earphone diaphragm according to claim 1, wherein the front cover is in the shape of a dome, and the circular through hole is provided at a center of the dome.

4. The protective front cover for an earphone diaphragm according to claim 1, wherein a top surface of the front cover is a plane, and the circular through hole is provided at a center of the top surface.

5. A protective front cover for an earphone diaphragm, wherein at least four arc through holes that form an annulus are provided at a center of the front cover, a periphery of the arc through holes is provided with an array of trapezoidal through holes that are spaced apart from each other and enclose the arc through holes, and a total area of the arc through holes and the trapezoidal through holes is 40% to 55% of an area of the front cover.

6. The protective front cover for an earphone diaphragm according to claim 5, wherein the front cover comprises a dome portion, an outer arc portion connected with an outer edge of the dome portion and a support connecting portion connected with an outer edge of the outer arc portion, the at least four arc through holes that form an annulus are provided at a center of the dome portion, and the array of trapezoidal through holes are provided on the outer arc portion.

7. The protective front cover for an earphone diaphragm according to claim 5, wherein the front cover is in the shape of a dome, and the at least four arc through holes that form an annulus are provided at a center of the dome.

8. The protective front cover for an earphone diaphragm according to claim 5, wherein a top surface of the front cover is a plane, and the at least four arc through holes that form an annulus are provided at a center of the top surface.
